(19) United States
(12) Patent Application Publication
(10) Pub. No.: US 2012/0050263 A1
(43) Pub. Date: Mar. 1, 2012

(54) 3D IMAGE PROCESSING APPARATUS AND METHOD FOR PROCESSING 3D IMAGES

(75) Inventor: Ho-woong KANG, Yongin-si (KR)

(73) Assignee: SAMSUNG ELECTRONICS CO., LTD., Suwon-si (KR)

(21) Appl. No.: 13/069,450

(22) Filed: Mar. 23, 2011

(30) Foreign Application Priority Data
Aug. 24, 2010 (KR) 2010-0082003

(51) Int. Cl. G06T 15/00

(52) U.S. Cl. 345/419

(57) ABSTRACT

A 3D image processing apparatus includes: an image processor which alternately receives a first main image frame and a second main image frame, which are different from each other, and a controller which controls the image processor to insert at least one first sub-image frame corresponding to the first main image frame after the first main image frame according to a pre-set frame rate, and to process the first main image frame, the first sub-image frame, and the second main image frame in sequence, wherein the first sub-image frame has a different pixel value from a pixel value of a previous image frame of the first sub-image frame and a pixel value of a next image frame of the first sub-image frame.

### CROSS-REFERENCE TO RELATED APPLICATION

This application claims priority from Korean Patent Application No. 10-2010-0082003, filed on Aug. 24, 2010, in the Korean Intellectual Property Office, the entire disclosure of which is incorporated herein by reference in its entirety.

### BACKGROUND

1. Field

Methods and apparatuses consistent with exemplary embodiments relate generally to a 3-dimensional (3D) image processing apparatus which improves image quality by performing dynamic capacitance compensation (DCC), and a method for processing a 3D image thereof.

2. Description of the Related Art

In general, a liquid crystal display (LCD), which is a representative display apparatus, is used for displaying an image on a monitor of a TV or a laptop computer. Since the LCD is not able to generate light by itself, the LCD has to use light emitted from an extra light source. Therefore, the LCD generally has a backlight unit disposed on a rear surface of a liquid crystal panel as a light source, and is configured to represent an image by adjusting a transmittance ratio of light emitted from the backlight unit according to movement of a liquid crystal.

The LCD scans a new image by updating a screen in a vertical period (in other words, on a frame basis), and retains the image during one frame until a scanning of a next vertical period arrives by capacitance of a liquid crystal.

However, the LCD is physically limited in terms of its response speed of the liquid crystal, which may cause a crosstalk phenomenon. The response speed of the liquid crystal may be improved by performing dynamic capacitance compensation (DCC).

However, since a related-art DCC processing method can still cause the crosstalk phenomenon, there is still a demand for preventing the crosstalk phenomenon.

### SUMMARY

One or more exemplary embodiments may overcome the above disadvantages and other disadvantages not described above. However, it is understood that one or more exemplary embodiments are not required to overcome the disadvantages described above, and may not overcome any of the problems described above.

One or more exemplary embodiments provide a 3-dimensional (3D) image processing apparatus, which sets a pixel value of at least one inserted image frame to be different from a pixel value of a previous image frame and a pixel value of a next image frame, and a method for processing a 3D image thereof.

According to an aspect of an exemplary embodiment, there is provided a method for processing a 3D image of a 3D image processing apparatus, the method including: alternately receiving a first main image frame and a second main image frame, which are different from each other, inserting at least one first sub-image frame corresponding to the first main image frame after the first main image frame according to a pre-set frame rate, and processing the first main image frame, the first sub-image frame, and the second main image frame in sequence. The first sub-image frame may have a different pixel value from a pixel value of a previous image frame of the first sub-image frame and a pixel value of a next image frame.

The method may further include, after the inserting, inserting at least one second sub-image frame corresponding to the second main image frame after the second main image frame according to the pre-set frame rate. The processing may include processing the first main image frame, the first sub-image frame, the second main image frame, and the second sub-image frame in sequence.

The first main image frame may be a left-eye image and the second main image frame may be a right-eye image.

The method may further include performing dynamic capacitance compensation (DCC) with respect to each pixel of the image frames processed in sequence.

If the pixel value of the first sub-image frame is made different from the pixel value of the previous image frame of the first sub-image frame and the pixel value of the next image frame of the first sub-image frame, the performing the DCC may include performing DCC a plurality of times corresponding to each difference in the pixel values.

The pixel value of the first sub-image frame may be a median value between the pixel value of the previous image frame of the first sub-image frame and the pixel value of the next image frame of the first sub-image frame.

The processing may include processing the pixel value of the first sub-image frame according to a following equation:

output.data(t,m,n)=data(t-1,m,n)+{data(t,m,n)−data(t-1,m,n)}*α

wherein t is a time, m is a horizontal position of a pixel, n is a vertical position of a pixel, and α is a variable greater than or equal to 0 and less than or equal to 1.

The processing may include dividing the first main image frame or the second main image frame into a plurality of areas and applying a different variable α to each of the divided areas.

The processing may include applying a different variable α to each of a plurality of pixels of the first main image frame or the second main image frame with reference to a motion index indicating change in a pixel value of each pixel.

According to an aspect of another exemplary embodiment, there is provided a 3D image processing apparatus, including: an image processor which alternately receives a first main image frame and a second main image frame, which are different from each other, and a controller which controls the image processor to insert at least one first sub-image frame corresponding to the first main image frame after the first main image frame according to a pre-set frame rate, and to process the first main image frame, the first sub-image frame, and the second main image frame in sequence. The first sub-image frame may have a different pixel value from a pixel value of a previous image frame of the first sub-image frame and a pixel value of a next image frame of the first sub-image frame.

The controller may control the image processor to insert at least one second sub-image frame corresponding to the second main image frame after the second main image frame according to the pre-set frame rate, and to process the first main image frame, the first sub-image frame, the second main image frame, and the second sub-image frame in sequence.

The first main image frame may be a left-eye image and the second main image frame may be a right-eye image.

The pixel value of the first sub-image frame may be a median value between the pixel value of the previous image frame of the first sub-image frame and the pixel value of the next image frame of the first sub-image frame.

The image processor may process the pixel value of the first sub-image frame according to a following equation:

output.data(t,m,n)=data(t-1,m,n)+{data(t,m,n)−data(t-1,m,n)}*α

wherein t is a time, m is a horizontal position of a pixel, n is a vertical position of a pixel, and α is a variable greater than or equal to 0 and less than or equal to 1.

The image processor may divide the first main image frame or the second main image frame into a plurality of areas and may apply a different variable α to each of the divided areas.

The image processor may apply a different variable α to each of a plurality of pixels of the first main image frame or the second main image frame with reference to a motion index indicating change in a pixel value of each pixel.

The 3D image processing apparatus may further include a liquid crystal panel which displays the image frames processed in sequence, and a liquid crystal driver which controls driving of each pixel of the liquid crystal panel.

The controller may control the liquid crystal driver to perform DCC with respect to each pixel of the image frames processed in sequence.

If the pixel value of the first sub-image frame is made different from the pixel value of the previous image frame of the first sub-image frame and the pixel value of the next image frame of the first sub-image frame, the controller may control the liquid crystal driver to perform DCC a plurality of times corresponding to each difference in the pixel values.

The 3D image processing apparatus may further include a sensor which senses an ambient temperature that changes a response speed of the liquid crystal, and the controller may control the image processor to set the pixel value of the first sub-image frame automatically according to the sensed ambient temperature.

Additional aspects and advantages of the exemplary embodiments will be set forth in the detailed description, will be obvious from the detailed description, or may be learned by practicing the exemplary embodiments.

### BRIEF DESCRIPTION OF THE DRAWING FIGURES

The above and/or other aspects will be more apparent by describing in detail exemplary embodiments, with reference to the accompanying drawings, in which:

FIG. 1 is a block diagram illustrating a 3-dimensional (3D) image processing apparatus according to an exemplary embodiment;

FIG. 2 illustrates a dynamic capacitance compensation (DCC) operation;

FIG. 3 illustrates an example of a lookup table (LUT) for performing the DCC operation;

FIGS. 4A and 4B are views to explain an operational principle of the 3D image processing apparatus according to an exemplary embodiment;

FIG. 5 is a flowchart illustrating a method for processing a 3D image of a 3D image processing apparatus according to an exemplary embodiment; and

FIG. 6 is a flowchart illustrating a method for processing a 3D image of a 3D image processing apparatus according to another exemplary embodiment.

### DETAILED DESCRIPTION OF THE EXEMPLARY EMBODIMENTS

Hereinafter, exemplary embodiments will be described in greater detail with reference to the accompanying drawings.

In the following description, same reference numerals are used for the same elements when they are depicted in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, functions or elements known in the related art are not described in detail since they would obscure the exemplary embodiments with unnecessary detail.

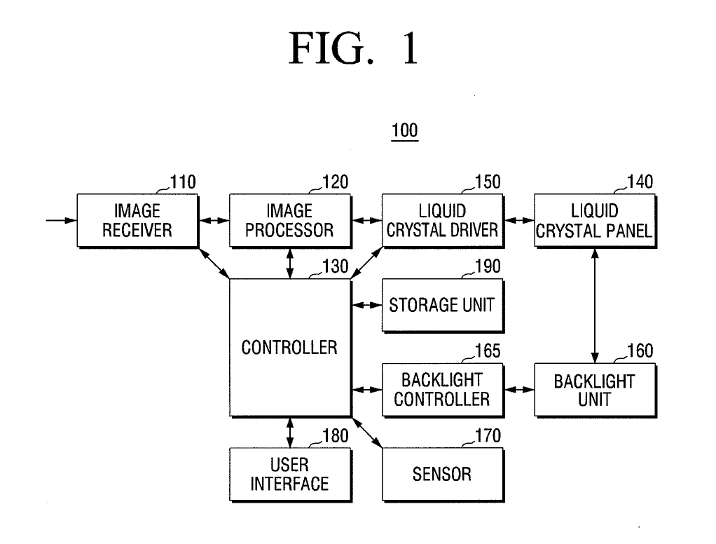

FIG. 1 is a block diagram illustrating a 3-dimensional (3D) image processing apparatus according to an exemplary embodiment.

Referring to FIG. 1, a 3D image processing apparatus 100 includes an image receiver 110, an image processor 120, a controller 130, a liquid crystal panel 140, a liquid crystal driver 150, a backlight unit 160, a backlight controller 165, a sensor 170, a user interface 180, and a storage unit 190.

The 3D image processing apparatus 100 may be included in a display apparatus such as a set-top box, a television, or any other apparatus related to displaying a 3D image.

According to an exemplary method for processing a 3D image, the image receiver 110 receives an image signal.

The image receiver 110 may receive a 2D image signal transmitted from a broadcasting station and may convert the received 2D image signal into a 3D image signal.

The image receiver 110 may receive a 3D image signal including a left-eye image and a right-eye image.

Each of the left-eye image and the right-eye image may be a single image frame. Also, the left-eye image may be a first main image frame and the right-eye image may be a second main image frame.

Hereinafter, the 3D image including the left-eye image and the right-eye image will be explained for convenience of explanation. However, the following explanation can be applied to other pairs of images, such as a 3D image including an upper image and a lower image.

The image processor 120 alternately receives the first main image frame and the second main image frame, which are different from each other.

After the first main image frame is input, the image processor 120 inserts at least one first sub-image frame corresponding to the first main image frame according to a pre-set frame rate. Also, the image processor 120 processes the first main image frame, the first sub-image frame, and the second main image frame, in sequence.

After the second main image frame is input, the image processor 120 inserts at least one second sub-image frame corresponding to the second main image frame according to the pre-set frame rate, and processes the first main image frame, the first sub-image frame, the second image frame, and the second sub-image frame, in sequence.

The at least one inserted first sub-image frame may be the same as the first main image frame, and the at least one inserted second sub-image frame may be the same as the second main image frame.

The “process” performed by the image processor 120 refers to all operations of making a pixel value of the at least one inserted first sub-image frame different from a pixel value of a previous image frame of the first sub-image frame and a pixel value of a next image frame of the first sub-image frame. Also, the “process” is applied to the at least one second sub-image frame inserted by the image processor 120 in the same manner.

If a frame rate of frames transmitted from a broadcasting station is 60 Hz (or 50 Hz), a signal output from the image receiver 110 may have a frame rate of 120 Hz including the first main image frame and the second main image frame. Therefore, the image frame output from the image processor 120 may have a pre-set frame rate of 240 Hz to 480 Hz.

For example, if the pre-set frame rate is 120 Hz, the first sub-image frame which is the same as the first main image frame is inserted and the second sub-image frame which is the same as the second main image frame is inserted.

In this case, the pixel value of the inserted first sub-image frame may be different from the pixel value of the previous image frame (i.e. the first main image frame) and the pixel value of the next image frame (i.e. the second main image frame). The pixel value of the inserted second sub-image frame may be set likewise.

If the pre-set frame rate is 240 Hz, three first sub-image frames which are the same as the first main image frame are inserted and three second sub-image frames which are the same as the second main image frame are inserted.

In this case, the pixel value of each of the inserted first sub-image frames may be different from the pixel value of the previous image frame and the pixel value of the next image frame. Also, the pixel value of each of the inserted second sub-image frames may be set likewise.

Since the first sub-image frame and the second sub-image frame have the pixel value between the previous image frame and the next image frame, the first sub-image frame and the second sub-image frame may be transient image frames.

The pixel value may be expressed by various values such as a grayscale value, a brightness value, and a luminance value. For example, the pixel value of the first sub-image frame may be a median value between the pixel value of the previous image frame of the first sub-image frame and the pixel value of the next image frame of the first sub-image frame.

The pixel value may be set differently according to at least one operational characteristic of the liquid crystal panel 140, such as an ambient temperature changing the response speed of the liquid crystal panel 140, a driving frequency of a received image, and/or an image processing effect. Also, the pixel value may be automatically set according to a result of sensing of the sensor 170, which will be described later.

The image processor 120 may output a pixel value for each color of an RGB color space or a YUV color space. For example, the image processor 120 may process the image frames such that specific pixel values for a plurality of pixels included in the liquid crystal panel 140 are output, and may process the image frames such that specific pixel values for R, G, B colors are output.

The controller 130 performs an overall controlling operation with respect to the elements included in the 3D image processing apparatus 100.

After the first main image frame is input, the controller 130 controls the image processor 120 to insert the at least one first sub-image frame corresponding to the first main image frame according to the pre-set frame rate, and to process the first main image frame, the first sub-image frame, and the second main image frame, in the recited sequence.

Also, after the second main image frame is input, the controller 130 controls the image processor 120 to insert the at least one second sub-image frame corresponding to the second main image frame according to the pre-set frame rate, and to process the first main image frame, the first sub-image frame, the second main image frame, and the second sub-image frame, in the recited sequence.

The controller 130 may control the liquid crystal driver 150 to perform dynamic capacitance compensation (DCC) with respect to each pixel of the image frames processed in sequence.

If the pixel value of the first sub-image frame is made different from the pixel value of the previous image frame and the pixel value of the next image frame, the controller 130 may control the liquid crystal driver 150 to perform the DCC a plurality of times corresponding to each difference in the pixel values.

The controller 130 may control the image processor 120 to output a different pixel value of the first sub-image frame or the second sub-image frame according to at least one of an ambient temperature, an operating frequency of a received image, and an image processing effect.

The controller 130 may control the image processor 120 to set a pixel value automatically according to the ambient temperature sensed by the sensor 170 and output the set pixel value.

For example, if the temperature of a liquid crystal included in the liquid crystal panel 140 increases, the controller 130 may control the image processor 120 to output a low pixel value because the response speed of the liquid crystal increases, and, if the temperature of the liquid crystal included in the liquid crystal panel 140 decreases, the controller 130 may control the image processor 120 to output a high pixel value because the response speed of the liquid crystal decreases.

As described above, since the 3D image processing apparatus is capable of setting the pixel value automatically according to the temperature, a lookup table (LUT) for processing the DCC is not required to be replaced every time the temperature changes, and the pixel value is automatically set without replacing the LUT during the image signal processing. Also, since a large memory space for storing a plurality of LUTs corresponding to different temperatures is not required, a good quality image can be provided in a relatively simple method.

The controller 130 may control the image receiver 110 or the image processor 120 to store the image to be output from the image receiver 110 or the image processor 120 at unit time intervals.

The liquid crystal panel 140 may display the image frames. Specifically, since the liquid crystal panel 140 is not able to generate light by itself, the liquid crystal panel 140 includes the backlight unit 160 disposed on a rear surface thereof as a light source, and represents the image frames by adjusting a transmission rate of light emitted from the backlight unit 160 according to the movement of the liquid crystal.

The liquid crystal panel 140 includes a plurality of pixels.

The liquid crystal panel 140 includes a first display plate and a second display plate facing each other and a liquid crystal interposed between the first display plate and the second display plate.

The liquid crystal included in the liquid crystal panel 140 has a response speed that changes according to an ambient temperature, an operating frequency of a received image, and/or an image processing effect.

The liquid crystal driver 150 controls driving of the image signal and provides the image signal to the liquid crystal panel 140.

The liquid crystal driver 150 may perform the DCC with respect to each of the pixels of the image frames processed in sequence.

Also, if the pixel value of the first sub-image frame is made different from the pixel value of the previous image frame of the first sub-image frame and the pixel value of the next image frame of the first sub-image frame, the liquid crystal driver 150 may perform the DCC a plurality of times corresponding to each difference in the pixel values.

The liquid crystal driver 150 may perform over-driving with respect to the image frames in order to perform the DCC.

The backlight unit 160 includes a plurality of light sources and may be driven in a hold type method such that the backlight unit 160 always maintains an on-state if power is supplied to the liquid crystal panel 140 or may be driven in a scanning method such that the light sources included in the backlight unit 160 are turned on from the upper one to the lower one in sequence.

The backlight controller 165 controls driving of the backlight unit 160.

For example, if the frame rate of the image frames output from the image processor 120 is 240 Hz, the backlight controller 165 controls the backlight unit 160 to be turned off during a first left-eye image period or a first right-eye image period with respect to images provided in order of a left-eye image, a left-eye image, a right-eye image, and a right-eye image.

The sensor 170 senses the ambient temperature which changes the response speed of the liquid crystal panel 140.

The user interface 180 receives a user command to set the pixel value for the image frame.

The 3D image processing apparatus 100 may set the pixel value automatically based on various factors (variables) that can change the response speed of the liquid crystal. These factors or variables depend on the information obtained by the sensor 170 or based on controlling performed by the controller 130. Alternatively, the 3D image processing apparatus 100 may receive a manual user command to set the pixel value through the user interface 180.

The storage unit 190 may store the lookup table for performing the DCC.

The storage unit 190 may store the image to be output from the image receiver 110 or the image to be output from the image processor 120.

The storage unit 190 may store a variable for calculating the pixel value according to the sensed ambient temperature.

The storage unit 190 may store mapping information of the various factors (variables) that change the response speed of the liquid crystal and the pixel values.

The 3D image processing apparatus 100 according to an exemplary embodiment includes the image processor 120 to alternately receive the first main image frame and the second main frame which are different from each other, and the controller 130 to control the image processor 120 to insert at least one first sub-image frame, corresponding to the first main image frame, after the first main image frame according to the pre-set frame rate, and to process the first main image frame, the first sub-image frame, and the second main image frame, in this sequence. The first sub-image frame may be set to have a pixel value which is different from the pixel value of the previous image frame and the pixel value of the next image frame.

In this case, the liquid crystal driver 150 may perform the DCC with respect to each pixel of the image frames processed in sequence. Accordingly, the response speed of the liquid crystal is improved and the crosstalk problem encountered in conventional systems is reduced.

According to an exemplary embodiment, the 3D image processing apparatus 100 is able to prevent an overlapping phenomenon of a left-eye image and a right-eye image, which may be caused by changes in the response speed of the liquid crystal included in the liquid crystal panel 140. Thus, since the 3D image processing apparatus 100 is able to optimize the response speed of the liquid crystal on a real time basis, based on the various factors and variables discussed earlier, the overlapping phenomenon of the left-eye image and the right-eye image can be efficiently prevented.

The 3D image processing apparatus 100 according to an exemplary embodiment may use a 3D image provided in order of a left-eye image, a left-eye image, a right-eye image, and a right-eye image (or in order of a right-eye image, a right-eye image, a left-eye image, and a left-eye image). However, the 3D image processing apparatus may use a 2D image in which the same image is repeated two times or a 2D image in which the same image is repeated four times.

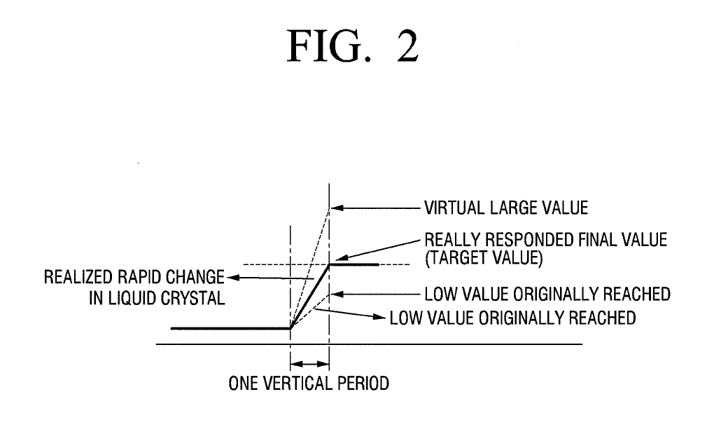

FIG. 2 explains the DCC operation.

In order to improve the response speed of the liquid crystal included in the liquid crystal panel 140, the 3D image processing apparatus 100 controls the liquid crystal driver 150 to perform the DCC with respect to the image frames output from the image processor 120.

The DCC refers to a method that induces the liquid crystal to reach a desired variation within a limited time by substituting a small variation of the liquid crystal with a large variation, even if the liquid crystal has a slow response speed.

Referring to FIG. 2, although there is a demand for changing a pixel value of the liquid crystal to a target pixel value as illustrated, during one vertical period (in other words, a time for processing a single image frame), the target pixel value may not be reached because the physical response speed of the liquid crystal is slow.

In this type of situation, the DCC makes it possible to reach the target pixel value in one vertical period by over-driving the liquid with a virtual large value by adding an arbitrary compensation value to the target pixel value.

In order to determine the arbitrary compensation value for the DCC operation, a lookup table is used.

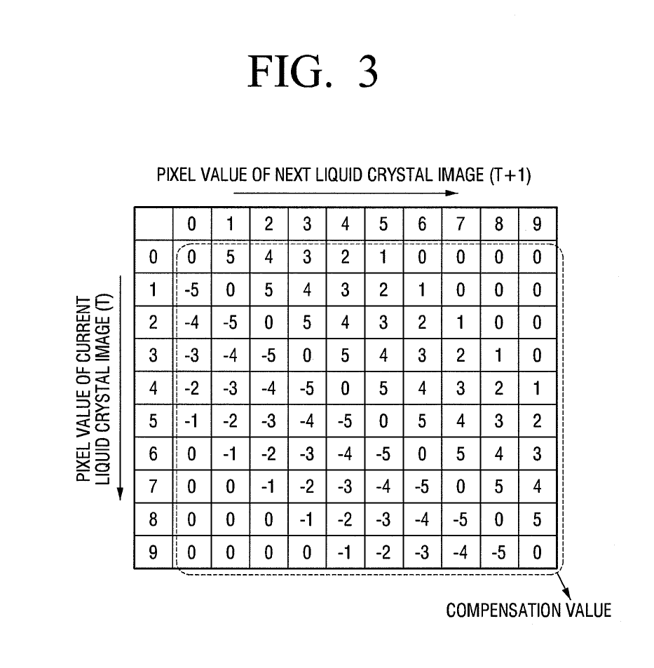

FIG. 3 provides an example of the lookup table for performing the DCC.

Referring to FIG. 3, pixel values of a current image frame are displayed in a vertical direction and range from 0 to 9. Pixel values of a next image frame are displayed in a horizontal direction and range from 0 to 9. Various compensation values are set and may be changeable according to the operational characteristics of the liquid crystal.

For example, if a pixel value of a specific pixel of the current image frame is 1 and a pixel value of a specific pixel of the next image frame is 5, the DCC is performed with respect to the specific pixel by adding a compensation value of 2 to the pixel value of the specific pixel of the next image frame, 5, so that the pixel value changes from 1 to 7 during the one vertical period. Accordingly, even if the liquid crystal response speed of the 3D image processing apparatus 100 is low, the pixel value of the specific pixel of the next image frame can reach the target pixel value of 5 during the one vertical period.

However, the pixel value of the specific pixel in the horizontal direction and the pixel value of the specific pixel in the vertical direction are not limited to 0-9 as illustrated.

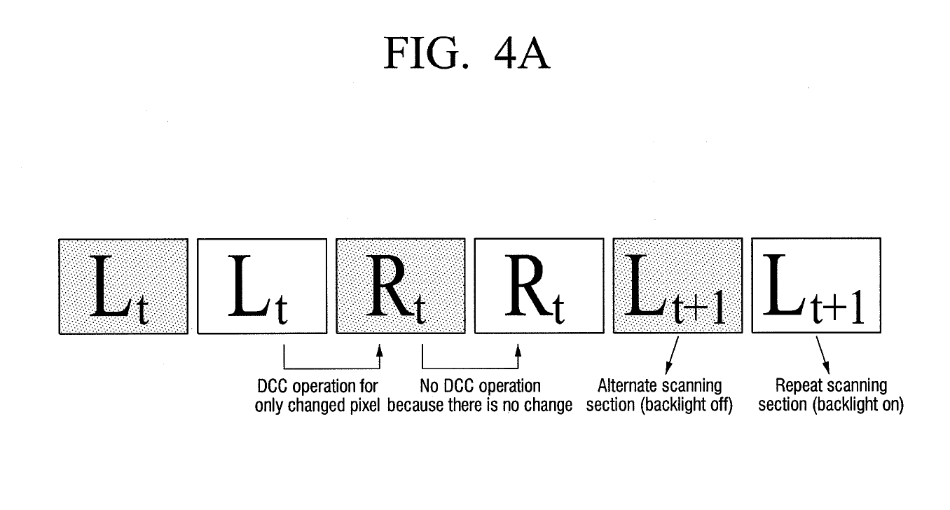

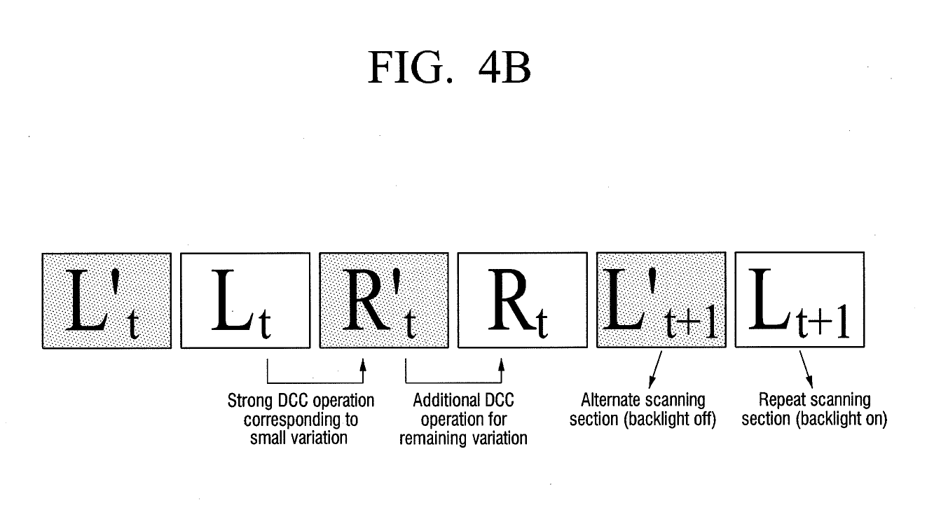

FIGS. 4A and 4B explain an operational principle of the 3D image processing apparatus according to an exemplary embodiment.

FIG. 4A is a view to explain an operational principle of a general image processing apparatus.

Referring to FIG. 4A, in order to process and display a 3D image, the 3D image processing apparatus 100 scans a left-eye image and a right-eye image, alternately, in order of the left-eye image, the left-eye image, the right-eye image and the right-eye image. In this case, if the liquid crystal included in the liquid crystal panel 140 does not have a required response speed in a section where the left-eye image and the right image are scanned alternately (in other words, in a section where the second left-eye image and the first right-eye image are scanned), the left-eye image and the right-eye image are overlapped and thus a crosstalk phenomenon emerging from at least one of the left-eye image and the right-eye image may be caused.

In order to prevent the crosstalk phenomenon, the backlight unit 160 may be turned off during a time when the first left-eye image and the first right-eye image appear. However, even in this case, the crosstalk phenomenon still occurs in the 3D image processing apparatus.

In order to improve the liquid crystal response speed of the 3D image processing apparatus 100, the DCC explained with reference to FIGS. 2 and 3 may be performed. However, if a variation of the liquid crystal is so slow that a desired pixel value is not achieved even if the DCC is performed once in the alternate scanning section where the second left-eye image and the first right-eye image are scanned, the DCC operation is not performed in the repeat scanning section (second right-eye image) and thus the crosstalk phenomenon still occurs.

In other words, referring to FIG. 4A, since the pixel value of the specific pixel changes in the section where the second left-eye image is changed to the first right-eye image, the DCC is performed in the 3D image processing apparatus 100. However, since the pixel value of the specific pixel does not change in the section where the first right-eye image is changed to the second right-eye image, the DCC is not performed in the 3D image processing apparatus 100.

As described above, if the DCC is performed once in the alternate scanning section, the crosstalk phenomenon still exists when the response speed of the liquid crystal is slow.

FIG. 4B is a view to explain an operational principle of the present disclosure which prevents this problem.

Referring to FIG. 4B, the backlight unit 160 is turned off when the first left-eye image and the first right-eye image are displayed, in the same way as in FIG. 4A. However, since the 3D image processing apparatus 100 of the present disclosure sets the first right-eye image and the second right-eye image to have different pixel values, the DCC is performed two times.

Referring to FIG. 3, the response speed improved by performing the DCC in the 3D image processing apparatus 100 of FIG. 4B will be explained in comparison with the response speed achieved by performing the DCC in the general image processing apparatus of FIG. 4A.

For example, it is assumed that the pixel value of the specific pixel of the second left-eye image is 1 and the pixel value of the same pixel of the first right-eye image is 5.

Referring to FIG. 4A, the general 3D image processing apparatus outputs the pixel values of 1→5→5 of the specific pixel of the second left-eye image, the first right-eye image, and the second right-eye image, and performs the DCC with respect to the output pixel values using the lookup table of FIG. 3, thereby outputting the pixel values of 1→7(5+2)→5(5+0).

Referring to FIG. 4B, the image processor 120 of the 3D image processing apparatus 100 of the present disclosure may output the pixel value of the first right-eye image, which is a predetermined value between the pixel value of 1 of the previous image frame and the pixel value of 5 of the next image frame, for example, 3.

Accordingly, the image processor 120 outputs the pixel values of 1→3→5 of the specific pixel of the second left-eye image, the first right-eye image, and the second right-eye image, and performs the DCC with respect to the output pixel values using the lookup table of FIG. 3, thereby outputting the pixel values of 1→7(3+4)→9(5+4).

The value 4 in the first bracket corresponds to a compensation value referred in the lookup table of FIG. 3 when the pixel value changes from 1 to 3, and the value 4 in the second bracket corresponds to a compensation value referred in the lookup table of FIG. 3 when the pixel value changes from 3 to 5.

Since the 3D image processing apparatus 100 performs the DCC two times, the response speed of the liquid crystal rapidly increases even if the physical response speed of the liquid crystal is slow, so that the crosstalk can be prevented.

In FIG. 4B, the image processor 120 determines and outputs the pixel value of 3 of the first image, which is a specific value between the pixel value of 1 of the previous image and the pixel value of 5 of the next image.

However, if the pixel value abruptly changes, distortion of the image (roughness of the image) may be caused. Therefore, the image processor 120 outputs the pixel value to have a median value between the pixel value of the previous image and the pixel value of the next image.

In this case, the pixel value may be set by the following equation 1:

output.data(t,m,n)=data(t-1,m,n)+{data(t,m,n)−data(t-1,m,n)}/2 [Equation 1]

wherein t is a time, m is a horizontal position of a pixel, and n is a vertical position of a pixel.

The pixel value may be automatically set by the following equation 2 in consideration of the factors discussed above that can change the operational characteristic of the liquid crystal:

output.data(t,m,n)=data(t-1,m,n)+{data(t,m,n)−data(t-1,m,n)}*α(0≦α≦1) [Equation 2]

wherein α is a variable greater than or equal to 0 and less than or equal to 1.

For example, if the temperature of the liquid crystal included in the liquid crystal panel 140 increases, the response speed of the liquid crystal increases. Therefore, the controller 130 may control the image processor 120 to set α to be close to 1 if the ambient temperature sensed by the sensor 170 increases. Also, if the ambient temperature sensed by the sensor 170 decreases, the controller 130 may control the image processor 120 to set α to be close to 0.

The DCC may be performed in different ways according to whether an operating frequency of a received image is 50 Hz or 60 Hz. Therefore, the controller 130 may control the image processor 120 to output different α in consideration of the operating frequency of the received image.

Also, the controller 130 may control the image processor 120 to output different variables α in consideration of diverse image processing effects for improving image quality.

According to an exemplary embodiment, if the response speed of the liquid crystal is sufficient, the 3D image processing apparatus 100 sets the variable α to 1 such that the image processor 120 outputs 1→5→5, and, if the response speed of the liquid crystal is insufficient, the 3D image processing apparatus 100 sets the variable α to 0.5 such that the image processor 120 outputs 1→7→9. Accordingly, the crosstalk phenomenon can be prevented and also the response speed of the liquid crystal can be optimized.

On the other hand, the image processor 120 may divide the first main image frame or the second main image frame into a plurality of areas, and may apply different variables α to the divided areas. For example, according to movement characteristics of the plurality of areas of the image frame, different variables α are applied to an area with a dynamic motion and an area with a slow motion.

Also, the image processor 120 may apply different variables α to a plurality of pixels of the first main frame or the second main frame with reference to a motion index indicating change in the pixel value of each pixel. For example, using the motion index indicating the degree of change in the pixel value of the specific pixel, the image processor 120 applies different variables α to a pixel with a dynamic motion and a pixel with a slow motion.

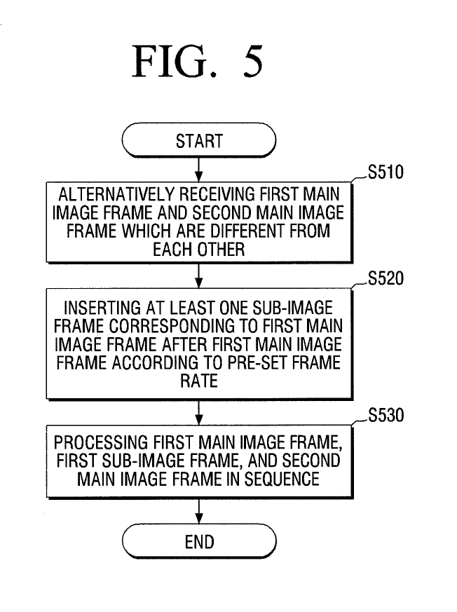

FIG. 5 is a flowchart illustrating a method for processing a 3D image of a 3D image processing apparatus according to an exemplary embodiment.

Referring to FIG. 5, the image processor 120 alternately receives a first main image frame and a second main image frame, which are different from each other (S510).

After the first main image frame is input, the image processor 120 inserts at least one first sub-image frame corresponding to the first main image frame according to a pre-set frame rate (S520).

The image processor 120 is controlled by the controller 130 to process the first main image frame, the second sub-image frame, and the second main image frame, in sequence (S530).

In this case, the first sub-image frame may have a different pixel value from a pixel value of a previous image frame and a pixel value of a next image frame.

The method for processing the 3D image may be implemented using a set top box having no display screen.

According to the method for processing the 3D image according to an exemplary embodiment, the first sub-image frame is inserted between the first main image frame and the second main image frame, and the first sub-image frame is the same as the first main image frame but is processed to have the different pixel value from the pixel values of the first main image frame and the second main image frame.

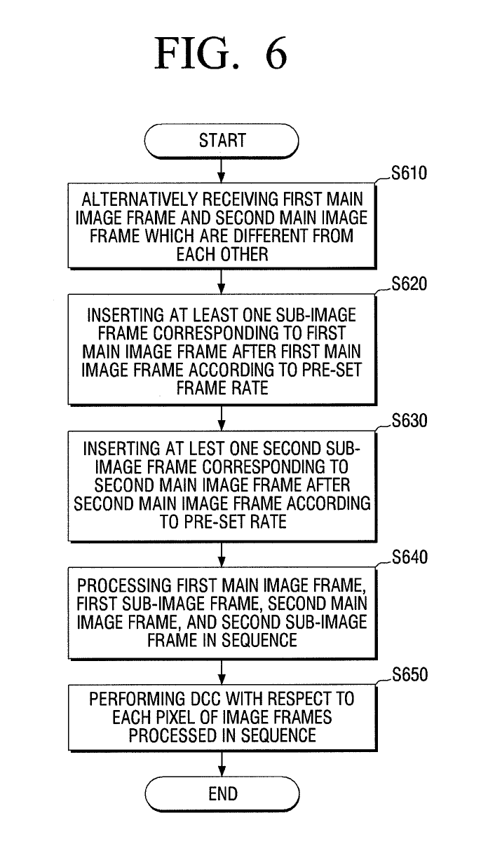

FIG. 6 is a flowchart illustrating a method for processing a 3D image of a 3D image processing apparatus according to another exemplary embodiment.

Referring to FIG. 6, the image processor 120 alternately receives a first main image frame and a second main image frame, which are different from each other (S610).

After the first main image frame is input, the image processor 120 inserts at least one first sub-image frame corresponding to the first main image frame according to a pre-set frame rate (S620).

Then, after the second main image frame is input, the image processor 120 inserts at least one second sub-image frame corresponding to the second main image frame according to the pre-set frame rate (S630).

Next, the image processor 120 is controlled by the controller 130 to process the first main image frame, the first sub-image frame, the second main image frame, and the second sub-image frame, in sequence (S640).

In this case, the first sub-image frame may have a different pixel value from a pixel value of a previous image frame and a pixel value of a next image frame, and the second sub-image frame may have a different pixel value form a pixel value of a previous image frame and a pixel value of a next image frame.

The liquid crystal driver 150 performs DCC with respect to each pixel of the image frames processed in sequence (S650).

The method for processing the 3D image may be implemented using a display apparatus having the liquid crystal panel 140 and the liquid crystal driver 150 such as a television.

According to the method for processing the 3D image according to exemplary embodiments, the DCC is performed a plurality of times, so that the response speed of the liquid crystal included in the liquid crystal panel 140 is improved and thus the crosstalk can be prevented.

Hereinafter, operations overlapping with the above-described operations are not explained.

The above embodiments relate to the 3D image processing apparatus 100 operating in the case that the liquid crystal panel 140 operates at 240 Hz. However, the above-described method can be applied to the case where the liquid crystal panel 140 operates at 480 Hz.

In this case, the controller 130 may control the image processor 120 to output a pixel value of a specific pixel of the first right-eye image, the second right-eye image, and the third right-eye image, as a pixel value between a pixel value of the fourth left-eye image (previous image) and a pixel value of the fourth right-eye image (next image).

For example, if the pixel value of the specific pixel of the fourth left-eye image (previous image) is 1 and the pixel value of the specific pixel of the right-eye image (next image) is 5, the controller 130 may control the image processor 120 to output the pixel values of the specific pixel of the first right-eye image, the second right-eye image, and the third right-eye image to be 2, 3, 4.

Also, if the liquid crystal panel 140 operates at 240 Hz, variables β and γ should be additionally defined besides variable α. However, it can be understood that variables β and γ operate in the same manner as variable α, and thus, a detailed explanation is not needed for a complete understanding of this embodiment of the invention.

The foregoing exemplary embodiments and advantages are merely exemplary and are not to be construed as limiting the present inventive concept. The exemplary embodiments can be readily applied to other types of apparatuses. Also, the description of the exemplary embodiments is intended to be illustrative, and not to limit the scope of the claims, and many alternatives, modifications, and variations will be apparent to those skilled in the art.

1. A method for processing a 3D image of a 3D image processing apparatus, the method comprising:
alternately receiving a first main image frame and a second main image frame, which are different from each other;
inserting at least one first sub-image frame corresponding to the first main image frame after the first main image frame according to a pre-set frame rate; and
processing the first main image frame, the first sub-image frame, and the second main image frame in sequence,
wherein the first sub-image frame has a different pixel value from a pixel value of a previous image frame of the first sub-image frame and a pixel value of a next image frame.

2. The method according to claim 1, wherein the inserting step further comprises inserting at least one second sub-image frame corresponding to the second main image frame after the second main image frame according to the pre-set frame rate,
wherein the processing comprises processing the first main image frame, the first sub-image frame, the second main image frame, and the second sub-image frame in sequence.

3. The method according to claim 1, wherein the first main image frame is a left-eye image and the second main image frame is a right-eye image.

4. The method according to claim 1, further comprising performing dynamic capacitance compensation (DCC) with respect to each pixel of the image frames processed in sequence.

5. The method according to claim 4, wherein, if the pixel value of the first sub-image frame is different from the pixel value of the previous image frame of the first sub-image frame and the pixel value of the next image frame of the first sub-image frame, the performing the DCC comprises performing DCC a plurality of times corresponding to each difference in the pixel values.

6. The method according to claim 1, wherein the pixel value of the first sub-image frame is a median value between the pixel value of the previous image frame of the first sub-image frame and the pixel value of the next image frame of the first sub-image frame.

7. The method as claimed in claim 1, wherein the processing comprises processing the pixel value of the first sub-image frame according to a following equation:
output.data(t,m,n)=data(t-1,m,n)+{data(t,m,n)−data(t-1,m,n)}*α
wherein t is a time, m is a horizontal position of a pixel, n is a vertical position of a pixel, and α is a variable greater than or equal to 0 and less than or equal to 1.

8. The method according to claim 7, wherein the processing comprises dividing the first main image frame or the second main image frame into a plurality of areas and applying a different variable α to each of the divided areas.

9. The method according to claim 7, wherein the processing comprises applying a different variable α to each of a plurality of pixels of the first main image frame or the second main image frame with reference to a motion index indicating change in a pixel value of each pixel.

10. A 3D image processing apparatus, comprising:
an image processor which alternately receives a first main image frame and a second main image frame, which are different from each other; and
a controller which controls the image processor to insert at least one first sub-image frame corresponding to the first main image frame after the first main image frame according to a pre-set frame rate, and to process the first main image frame, the first sub-image frame, and the second main image frame in sequence,
wherein the first sub-image frame has a different pixel value than a pixel value of a previous image frame of the first sub-image frame and a pixel value of a next image frame of the first sub-image frame.

11. The 3D image processing apparatus according to claim 10, wherein the controller controls the image processor to insert at least one second sub-image frame corresponding to the second main image frame after the second main image frame according to the pre-set frame rate, and to process the first main image frame, the first sub-image frame, the second main image frame, and the second sub-image frame in sequence.

12. The 3D image processing apparatus according to claim 10, wherein the first main image frame is a left-eye image and the second main image frame is a right-eye image.

13. The 3D image processing apparatus according to claim 10, wherein the pixel value of the first sub-image frame is a median value between the pixel value of the previous image frame of the first sub-image frame and the pixel value of the next image frame of the first sub-image frame.

14. The 3D image processing apparatus according to claim 10, wherein the image processor determines the pixel value of the first sub-image frame according to a following equation:
output.data(t,m,n)=data(t-1,m,n)+{data(t,m,n)−data(t-1,m,n)}*α
wherein t is a time, m is a horizontal position of a pixel, n is a vertical position of a pixel, and α is a variable greater than or equal to 0 and less than or equal to 1.

15. The 3D image processing apparatus according to claim 14, wherein the image processor divides the first main image frame or the second main image frame into a plurality of areas and applies a different variable α to each of the divided areas.

16. The 3D image processing apparatus according to claim 14, wherein the image processor applies a different variable α to each of a plurality of pixels of the first main image frame or the second main image frame with reference to a motion index indicating change in a pixel value of each pixel.

17. The 3D image processing apparatus according to claim 10, further comprising:
a liquid crystal panel which displays the image frames processed in sequence; and
a liquid crystal driver which controls driving of each pixel of the liquid crystal panel.

18. The 3D image processing apparatus according to claim 17, wherein the controller controls the liquid crystal driver to perform DCC with respect to each pixel of the image frames processed in sequence.

19. The 3D image processing apparatus according to claim 18, wherein, if the pixel value of the first sub-image frame is different from the pixel value of the previous image frame of the first sub-image frame and the pixel value of the next image frame of the first sub-image frame, the controller controls the liquid crystal driver to perform DCC a plurality of times corresponding to each difference in the pixel values.

20. The 3D image processing apparatus according to claim 17, further comprising a sensor which senses an ambient temperature that changes a response speed of the liquid crystal,
wherein the controller controls the image processor to set the pixel value of the first sub-image frame automatically according to the sensed ambient temperature.

21. (canceled)

22. (canceled)
